(19) United States
(12) Patent Application Publication
(10) Pub. No.: US 2017/0220712 A1
(43) Pub. Date: Aug. 3, 2017

(54) COMPUTER-IMPLEMENTED METHOD FOR SIMULATING A RESTBUS CONTROL UNIT NETWORK

(71) Applicant: dSPACE digital signal processing and control engineering GmbH, Paderborn (DE)

(72) Inventors: Matthias BLESKEN, Paderborn (DE); Martin HOETGER, Bad Wuennenberg (DE); Bjoern MUELLER, Paderborn (DE)

(73) Assignee: dSPACE digital signal processing and control engineering GmbH, Paderborn (DE)

(21) Appl. No.: 15/423,663

(22) Filed: Feb. 3, 2017

(30) Foreign Application Priority Data
Feb. 3, 2016 (DE) 10 2016 101 853.8
Feb. 3, 2016 (EP) 16154002.6

(51) Int. Cl. G06F 17/50; G06F 13/42

(52) U.S. Cl. CPC G06F 17/509; G06F 13/4208

(57) ABSTRACT

A computer-implemented method for simulating a restbus control unit network that includes at least two restbus control units connected through a bus system. The restbus control unit network is connected to at least one additional control unit through the bus system. The communication relationships of the restbus control units are described, program code for simulating the restbus control units is generated based on the communication relationships. The restbus control unit network is simulated on a simulation computer via an executable version of the program code. Simplified and flexible simulation of the restbus control unit network is made possible in that a single, joint restbus control unit model is generated for the restbus control units as program code for simulating the restbus control units.

This nonprovisional application claims priority under 35 U.S.C. §119(a) to European Patent Application No. 16154002.6, which was filed in Europe on Feb. 3, 2016, and to German Patent Application No. 10 2016 101 853.8, which was filed in Germany on Feb. 3, 2016, and which are both herein incorporated by reference.

### BACKGROUND OF THE INVENTION

Field of the Invention

The invention relates to a computer-implemented method and device for simulating a restbus control unit network, wherein the restbus control unit network includes at least two restbus control units connected through a bus system and the restbus control unit network is connected to at least one additional control unit through the bus system, wherein the communication relationships of the restbus control units are described, program code for simulating the restbus control units is generated on the basis of the communication relationships, and the restbus control unit network is simulated on a simulation computer by means of an executable version of the program code.

Description of the Background Art

Methods of the aforementioned type are known in the prior art, and are frequently used in testing of real control units that are part of a control unit network or are intended to be part of a control unit network. Control units are generally understood to be small computers with at least one I/O interface (I/O=Input/Output), which oftentimes are equipped with a real-time operating system that allows the implementation of tasks on the control unit—including complex tasks—that are generally of a feedback control nature. Control unit development is a central element of the technical development of comprehensive hardware systems such as are known from industrial practice. Control units that are connected through a bus system (e.g., CAN, FlexRay, LIN) to form a distributed network of small computers are standard applications, for example in the automotive industry and in aerospace.

Testing of a (mass produced) control unit employed in the end product is the endpoint of multiple preceding development steps of a regulation or control system to be implemented on the control unit, wherein these development steps usually are described with the so-called V-model or else Z-cycle. Controller development, which is essential for functionality of many technical systems, starts off with the mathematical modeling of the control algorithm on a computer with a mathematical and graphical modeling environment, wherein the controller should be considered a part of the control unit. In addition, the environment of the control unit is also modeled mathematically, since the interaction of the controller on the control unit with the process to be controlled is of interest. In these functional mathematical considerations, simulation in real time generally is not necessary (offline simulation).

In the next step, the control algorithm devised previously is transferred, using rapid control prototyping, to a powerful hardware unit, usually a hardware unit that is real-time-capable, which is connected to the actual physical process by suitable I/O interfaces, which is to say to a motor vehicle engine, for instance. Generally speaking, this real-time-capable hardware unit has nothing to do with the mass produced control unit that will later be employed; at issue here is proof of the basic functionality in practice of the previously devised control.

In another step, as part of automatic production code generation, the control is implemented on the target processor that is likely to actually be employed later in the mass produced control unit. Accordingly, in this step, the target hardware approximates the mass produced control unit, but is not identical to the mass produced control unit.

In another step, the mass produced control unit—which normally does not exist until a later development stage—is tested in the framework of a hardware-in-the-loop (HIL) test. This is the most important application for the above-described method for simulating a restbus control unit network. The (mass produced) control unit physically present in this step is connected by means of its physical control unit interface to a powerful simulation computer here, often simply referred to as a simulator. The simulator simulates the required variables of the real control unit under test, and exchanges input and output variables with the control unit. The pins of the physical control unit interface of the control unit are connected to the simulator by a cable harness. In this way, it is possible to simulate all required variables, for example of a motor vehicle engine—if applicable the entire motor vehicle with engine, drive train, chassis, and driving route—in the simulation environment, and to test the behavior of the control unit in interaction with the simulation environment in a risk-free manner.

In the applications considered here, the control unit under test is connected through a bus system to other control units, wherein these other control units make up the restbus control unit network. If the restbus control unit network does not actually exist (yet), then the control units of the restbus control unit network must be simulated on the simulation computer in order to test the other control unit, which is present as an actual device. To this end, it is necessary to ascertain and describe the communication relationships of the restbus control units. Program code for simulating the restbus control units can then be generated on the basis of the communication relationships; often this is code in a high-level programming language (for example, “C” or “C++”). Frequently, this program code is then translated into an executable version of the program code with a compiler suitable for the simulation computer, and is executed on the simulation computer.

Depending on the complexity of the restbus control unit network, simulation of the control units of the restbus control unit network in the prior art is associated with use of considerable resources, and specifically with considerable hardware resources as well as considerable software resources. A known approach separately simulates the restbus control units of the restbus control unit network. To this end, software components of the restbus control units (runtime environment, system services, communication services, I/O hardware abstraction layer, etc.) are—at least partly—modeled as part of a so-called virtual control unit, depending on the level of abstraction, and are simulated with a simulator (dSPACE Catalog 2014: “SystemDesk V-ECU Generation Module” and “dSPACE Offline Simulator”).

The simulator can be one or more specialized computers, for example in the form of an HIL test stand, but a commercial PC can also be used as the simulator. Each restbus control unit is modeled separately and is simulated on a separate hardware computing unit, which is to say on its own simulation board, its own processor, or at the very least its own core of a processor within the simulation computer.

### SUMMARY OF THE INVENTION

It is therefore an object of the present invention to further develop the aforementioned method for simulating a restbus control unit network such that it is possible to simulate the restbus control unit network more simply and more flexibly.

In an exemplary embodiment of the method for simulating a restbus control unit network on which the invention is based, a single, joint restbus control unit model is generated for the restbus control units as program code for simulating the restbus control units. It is an advantage of the method according to the invention that a restbus simulation that is simplified compared to the prior art is now also possible in which the totality of the restbus control units can be simulated jointly since they are based on a single, joint restbus control unit model.

Accordingly, the messages exchanged between the restbus control units need no longer be exchanged through external interfaces outside of the joint restbus control unit model, but instead can be exchanged within the restbus control unit model. The only messages the restbus control unit model must still output externally are the messages that are relevant for the other control unit connected to the simulated restbus control units through the bus system. Simulation of the restbus control unit network can now be achieved substantially more simply than has previously been possible.

For the applications considered here of simulating the restbus control unit network on a simulation computer, the simulation computer is usually connected to an actual technical process, namely at least to the other (actual) control unit. The data generated within the framework of executing the program code of the single, joint restbus control unit model also relate, of course, to data that are transmitted through appropriate I/O interfaces to the bus system and that thus physically influence the connected actual technical process—at least in the form of the other connected control unit.

In an embodiment of the method, provision is made that the description of the communication relationships of the restbus control units is accomplished by specifying a communication matrix that includes the restbus control units and the communication elements exchanged between the restbus control units. This involves a description of the communication elements, for example in the form of PDUs (Protocol Data Units), that are exchanged between the communication partners of the restbus control unit network, which is to say between the restbus control units.

According to an enhancement of the simulation method, provision is made that the restbus control units are jointly simulated in an executable version of the restbus control unit model, in particular are simulated in a single process on the simulation computer. This variant once again demonstrates the tremendous advantage of the method, which makes it possible in the first place to compute all restbus control units on the simulation computer in a single process.

An embodiment of the method is distinguished in that the joint restbus control unit model can be generated as a virtual control unit. As a result, it is possible to simulate the restbus control unit network using only a single virtual control unit in those simulation environments that operate with the above-described virtual control units (V-ECU implementations). With the customary approach of using a standalone computing unit of the simulation computer for simulating a virtual control unit, the entire restbus control unit network is thus automatically simulated on a single computing unit.

In an embodiment of the method, provision is made that the restbus control unit model can be generated as a functional mock-up unit (FMU) which, in particular, has a functional mock-up interface (FMI). The exact representation of the restbus control units within the joint restbus control unit model is not necessarily the important thing here, instead, what is important is that the functional mock-up unit has an interface that allows use in another modeling or simulation environment or the coupling of different modeling or simulation environments. Thus it is possible to carry out, in any desired modeling or simulation environment, a restbus simulation in which communication takes place on a simulated or actual bus system. The generation of the functional mock-up unit makes provision in this respect that, for example, a restbus block (in the case of a block-based modeling environment) of the modeling or simulation environment is provided with appropriate information, wherein the correct representation of the bus interface is especially important. The generation of the functional mock-up unit and of the functional mock-up interface can be based on the FMI/FMU standard (Functional Mock-up Interface/Functional Mock-up Unit).

In an embodiment of the method, provision is made that the restbus control unit model can be generated for an offline simulation environment, for example as a Simulink model or as a file container together with an environment model (for instance, a Simulink model or program code generated therefrom) and/or descriptions of program interfaces of the file container or of the restbus control unit model.

An embodiment of the method provides that at least parts of the restbus control unit model meet the Automotive Open System Architecture Standard (AUTOSAR).

An embodiment of the method provides that the restbus control units in the joint restbus control unit model can each be represented by platform-independent program code excluding program code for the bus interface, and the platform-independent portions of the bus interface of the restbus control units are represented in a joint interface program code, wherein the joint interface program code describes the specifically configured bus interfaces of all restbus control units. As a result, this means that a superset interface is created for all restbus control units of the restbus control unit network, through which all communication of the restbus control unit network with the environment is transacted.

In an embodiment, provision is made that the restbus control units in the joint restbus control unit model can each be represented by platform-independent program code with the portion of the relevant bus interface, so that the platform-independent program code describes the specifically configured bus interface of the relevant restbus control unit. Consequently, each restbus control unit has its own implementation of the relevant bus interface used.

The platform-independent program code can then be obtained in a relatively simple manner if the real-time simulation code having a hardware configuration and a restbus configuration of an HIL application is already present. The hardware-independent program code of the restbus control unit network above the interface program code can then be obtained through extraction from the application code of the HIL application.

The program code of the joint restbus control unit model can be equipped with a manipulation interface through which different faults can be triggered within the restbus control unit network. In this way, selective fault injection (failure injection) and fault simulation are possible within the restbus network.

In an embodiment of the method, provision is made that the restbus control unit model can be stored as a data container having the program code for the restbus control units, at least one parameter file, and in particular also program code of a system model to which the restbus control units are connected. The parameter file here can include, for instance, an interface description and/or a variable description for access to global variables during a simulation, e.g., in the form of A2L or TRC formats.

As a result, with the above-described method it is possible not only to simulate a restbus control unit network, but also to generate a model for simulating a restbus control unit network, wherein the restbus control unit network includes at least two restbus control units connected through a bus system and the restbus control unit network is connected to at least one additional control unit through the bus system, wherein the communication relationships of the restbus control units are described and a single, joint restbus control unit model is generated for the restbus control units as program code for simulating the restbus control units, so that the restbus control units are jointly simulated in an executable version of the restbus control unit model.

The invention additionally relates to a computer program product with a computer program that has software for carrying out the above-described method for simulating a restbus control unit network when the computer program is executed on a computer.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a computer-implemented method for simulating a restbus control unit network, as is known from the prior art,

FIG. 2 is a method according to the invention for simulating a restbus control unit network,

FIG. 3 is a computer-implemented method in which the restbus control unit model is designed as a functional mock-up unit,

FIG. 4 is a computer-implemented method in which the functionality of the bus interface is represented in a joint interface program code, and

FIG. 5 is a computer-implemented method in which the program code for the restbus control units includes the portion of the relevant bus interface.

### DETAILED DESCRIPTION

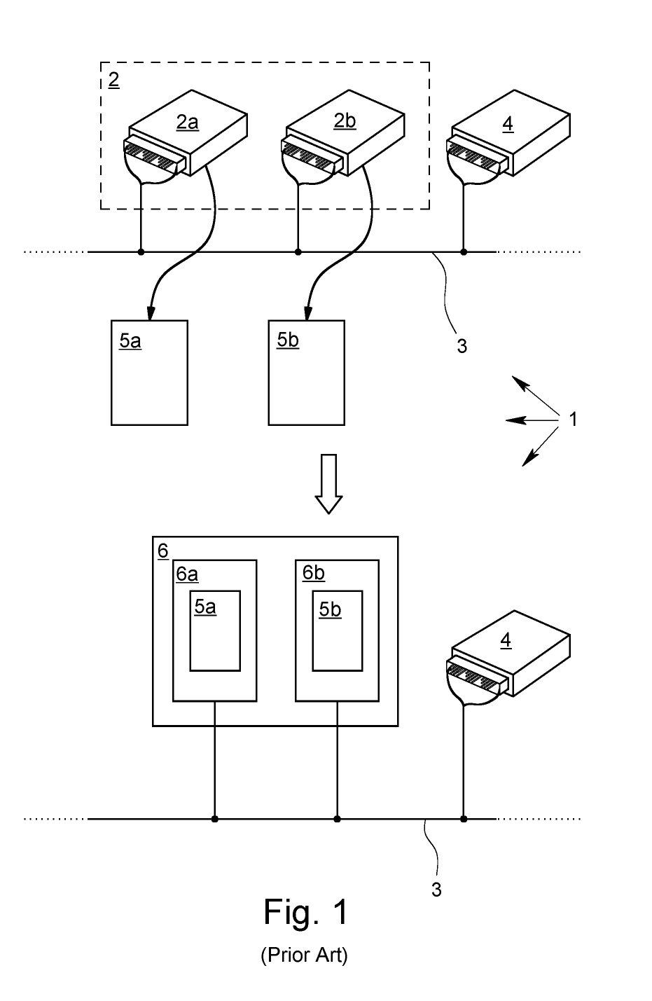

Shown in FIG. 1 is a computer-implemented method 1 for simulating a restbus control unit network 2 such as is already practiced in the prior art. Shown at the top in FIG. 1, firstly, is a control unit network with a total of three control units 2a, 2b, and 4, which are connected to one another through a bus system 3.

In the present case, the engineering task is that the control unit 4 is present as an actual control unit and is to be tested with respect to its functionality in interaction with the other control units 2a, 2b. If—for whatever reason—the control units 2a, 2 are not actually present, these control units 2a, 2b are simulated. From the point of view of the control unit 4 under test, the two control units 2a, 2b together constitute the restbus control unit network 2. If the functionality of the restbus control units 2a, 2b is known, then the communication relationships of the restbus control units 2a, 2b can also be described. Program code 5a, 5b for simulating the restbus control units 2a, 2b is then generated on the basis of the communication relationships.

It can be seen at the bottom of FIG. 1 that the restbus control unit network 2 is simulated on a simulation computer 6 by means of an executable version of the program code 5a, 5b. The simulation computer 6, which is only shown schematically here, is an HIL test stand. It is typically the case that a separate program code 5a, 5b is generated for each of the restbus control units 2a, 2b and this program code 5a, 5b is executed separately on different units 6a, 6b of the simulation computer 6. The simulation computer units 6a, 6b here are separate plug-in cards within the HIL simulator 6, each with its own processor and its own I/O interfaces through which they are connected to the bus system 3. In the exemplary embodiment shown, the restbus control units 2a, 2b are implemented as separate virtual control units (V-ECU).

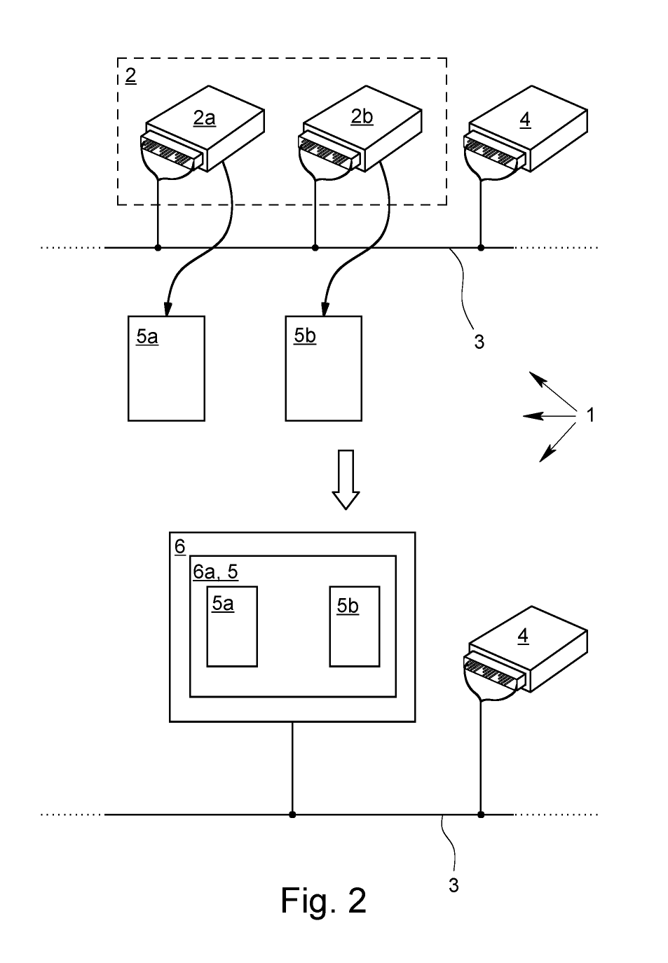

It is shown in FIG. 2 that only one single, joint restbus control unit model is generated for the restbus control units 2a, 2b as program code 5 for simulating the restbus control units 2a, 2b. The comprehensive program code 5 may have code sections 5a, 5b that are directly related to the functionality of the restbus control units 2a, 2b, but the functionality of all restbus control units 2a, 2b is represented in the single program code 5 that is executable, and is executed, as a comprehensive program code 5.

It is an advantage of the method shown that a restbus simulation that is simplified compared to the method from FIG. 1 is possible in which the totality of the restbus control units 2a, 2b can be simulated jointly since they are based on a single, joint restbus control unit model or a single, joint program code 5. The messages exchanged between the restbus control units 2a, 2b can be exchanged within the restbus control unit model or within the program code 5 based thereon. The only data that the restbus control unit model and the program code 5 based thereon still must output externally, e.g., as a response to receiving data from the other control unit 4, are the data that are of interest to the other control unit 4. In this way the simulation of the restbus control unit network 2 can be implemented very easily.

Furthermore, there is also no need for multiple computing units 6a, 6b on the simulation computer 6 for simulating the restbus control unit network 2; instead, only the presence of a single computing unit 6a or 6b in the simulation computer 6 is necessary in order to simulate the entire restbus control unit network 2; this is also shown in FIG. 2.

The generation of a single, joint restbus control unit model as program code 5 for the restbus control units 2a, 2b has the result that the restbus control units 2a, 2b are jointly simulated during execution on the simulation computer 6 or on the simulation computing unit 6a. In the present case, the restbus control units 2a, 2b are simulated in a single process within the framework of the execution of the program code 5 on the computing unit 6a of the simulation computer 6. With the method presented it is thus possible for the entire restbus control unit network 2 and the joint restbus control unit model associated therewith to be generated as a single virtual control unit and—as shown in FIG. 2—to be executed and simulated by a single virtual control unit.

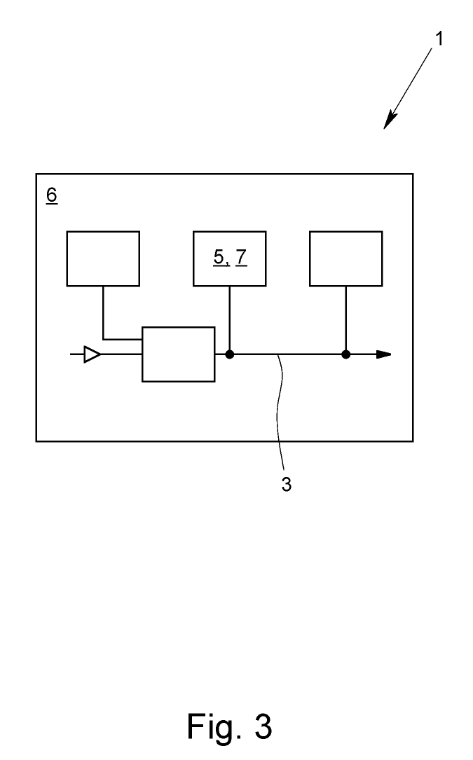

The method presented here for simulating a restbus control unit network 2 opens up yet more extensive options permitting simple handling of an entire restbus control unit network 2 even in a different simulation context. It is shown in FIG. 3 that the restbus control unit network 2, and thus also the associated restbus control unit model, are generated as a functional mock-up unit 7, and are simulated on a simulation computer 6 within the scope of another simulation environment. In the present case, the simulation computer 6 is a conventional PC on which a block-based simulation environment is operated, which is indicated by the schematically represented block diagram.

In the block-based modeling environment shown, the program code 5 for the restbus control unit network 2 is stored for a restbus block. The simulation environment here is an offline simulation environment in which the simulation of the restbus control unit network 2 does not necessarily need to take place in real time. The advantage of a simplified overall representation and simulation implementation of the restbus control unit network 2 by the program code 5 of a single, joint restbus control unit model is preserved here as well, however.

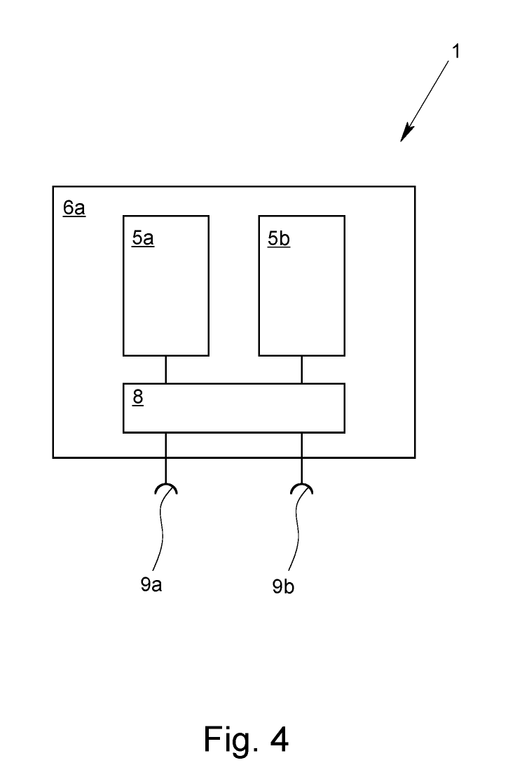

FIG. 4 shows a special embodiment of the above-described method for simulating a restbus control unit network 2. What is important here is that the restbus control units 2a, 2b in the joint restbus control unit model are each represented by platform-independent program code 5a, 5b, wherein the program code 5a, 5b does not contain any program code for the bus interface. The platform-independent portions of the bus interface of the restbus control units 2a, 2b are then represented in a joint interface program code 8, wherein the joint interface program code 8 describes the specifically configured bus interfaces of the restbus control units 2a, 2b. The interface program code 8 thus constitutes a superset interface for all restbus control units 2a, 2b. The interfaces 9a, 9b that are sketched then represent interfaces to an external bus interface and to the operating system of the simulation computer 6 or of the computing unit 6a of the simulation computer 6.

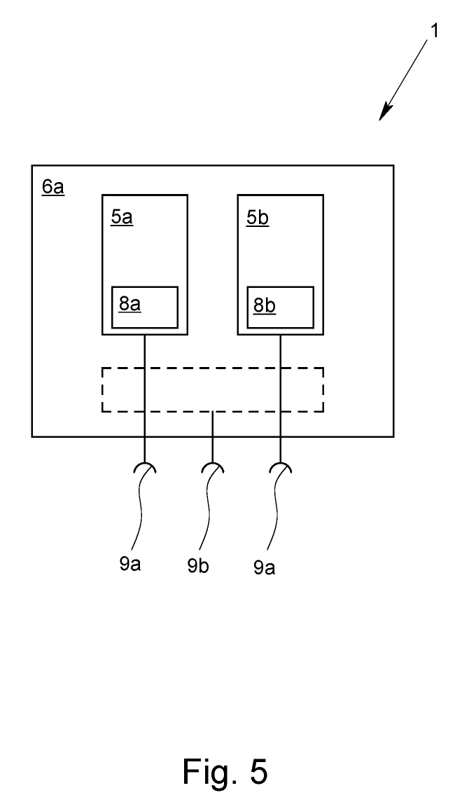

FIG. 5 shows an alternative variant for implementing the bus interfaces of the restbus control units 2a, 2b as compared with the embodiment in FIG. 4. Here, the restbus control units 2a, 2b in the joint restbus control unit model are each represented by platform-independent program code 5a, 5b with the portion of the relevant bus interface 8a, 8b, so that the platform-independent program code 5a, 5b, 8a, 8b describes the specifically configured bus interface of the relevant restbus control unit 2a, 2b. The program code for the bus interface 8a, 8b here is accordingly integrated into the restbus implementation. The platform-independent program code 5a, 5b of each individual restbus control unit 2a, 2b can thus separately enter into connection with the external bus system, not shown here, through the sketched interface 9a. Furthermore, an interface 9b is again provided for interaction with the operating system of the simulation computer 6 or the computing unit 6a of the simulation computer 6.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for simulating a restbus control unit network that includes at least two restbus control units connected through a bus system, the method comprising:
connecting the restbus control unit network to at least one additional control unit through the bus system, communication relationships of the restbus control units being described;
generating program code for simulating the restbus control units based on the communication relationships;
simulating the restbus control unit network on a simulation computer via an executable version of the program code; and
generating a single, joint restbus control unit model for the restbus control units as program code for simulating the restbus control units.

2. The computer-implemented method according to claim 1, wherein the description of the communication relationships of the restbus control units is performed by specifying a communication matrix that includes the restbus control units and the communication elements exchanged between the restbus control units.

3. The computer-implemented method according to claim 1, wherein the restbus control units are jointly simulated in an executable version of the restbus control unit model or are simulated in a single process on the simulation computer.

4. The computer-implemented method according to claim 1, wherein the joint restbus control unit model is generated as a virtual control unit.

5. The computer-implemented method according to claim 1, wherein the restbus control unit model is generated as a functional mock-up unit that has a functional mock-up interface.

6. The computer-implemented method according to claim 1, wherein the restbus control unit model is generated for an offline simulation environment or as a Simulink model in the form of a Simulink implementation container.

7. The computer-implemented method according to claim 1, wherein at least parts of the restbus control unit model meet the Automotive Open System Architecture Standard.

8. The computer-implemented method according to claim 1, wherein the restbus control units in the joint restbus control unit model are each represented by platform-independent program code excluding program code for the bus interface, wherein the platform-independent portions of the bus interface of the restbus control units are represented in a joint interface program code, and wherein the joint interface program code describes the specifically configured bus interfaces of all restbus control units.

9. The computer-implemented method according to claim 1, wherein the restbus control units in the joint restbus control unit model are each represented by platform-independent program code with a portion of the relevant bus interface so that the platform-independent program code describes the specifically configured bus interface of the relevant restbus control unit.

10. The computer-implemented method according to claim 1, wherein the program code of the joint restbus control unit model is equipped with a manipulation interface through which different faults can be triggered within the restbus control unit network.

11. The computer-implemented method according to claim 1, wherein the restbus control unit model is stored as a data container having the program code for the restbus control units, at least one parameter file, and program code of a system model with which the restbus control units are connected.

12. A computer program product with a computer program that has software for carrying out the method according to claim 1 when the computer program is executed on a computer.
